(19) United States
(12) Patent Application Publication
(10) Pub. No.: US 2014/0343697 A1
(43) Pub. Date: Nov. 20, 2014

(54) Selectable Operating Modes for Machine Operator Input Devices

(71) Applicant: Caterpillar Inc., Peoria, IL (US)

(72) Inventor: Beau D. Kuipers, Morris, IL (US)

(73) Assignee: Caterpillar Inc., Peoria, IL (US)

(21) Appl. No.: 13/897,148

(22) Filed: May 17, 2013

(51) Int. Cl. G05B 15/02

(52) U.S. Cl. CPC G05B 15/02
USPC 700/85; 700/83

(57) ABSTRACT

A machine supports multiple selectable operating modes for operator input devices. An operator input device and associated input sensor convert physical operator actions into operator input control signals. A force feedback device, associated with the operator input device, exerts a resistive force based upon force feedback signals issued by the programmed controller. A machine subsystem includes an actuator configured to change an operational state of the machine according to machine control commands issued by the programmed controller based upon the operator input control signals. An operator input device configuration unit receives directions for specifying an operator input device configuration definition. The operator input device configuration definition specifies a mapping between the operator input control signals and the machine control commands. The operator input device configuration definition specifies at least an operator input device mode, and a force feedback mode based at least in part upon the operator input device mode.

### TECHNICAL FIELD

This patent disclosure relates generally to electrical systems and components within a machine and, more particularly to an operator control interface (e.g., joystick, steering wheel, etc.) converting physical operator actions into electronic signals that, in turn result in mechanical actuation of controlled machine components (e.g., steered wheels, a scoop shovel, a grader blade, etc.) on a work machine.

### BACKGROUND

Machines such as, for example, cars, trucks, wheel loaders, backhoes, and tractors, include motion-control systems that have one or more operator-moveable input devices that regulate the motion of one or more moveable components of a machine, such as ground wheels and implements/tools. Some such motion-control systems include an operator interface associated with the moveable input device, such as a joystick, steering wheel, or a pedal, that an operator uses to provide an input to the motion-control system. Machines are often equipped with one or more of the above-mentioned moveable input devices to facilitate a variety of operator-initiated controls for the machine.

There are many ways in which input actions by an operator are translated to machine/implement control operations. In some instances, an operator input device provides inputs to regulate the motion of the moveable components through a mechanical connection. Such mechanical connections can transmit force feedback from the moveable components to the operator input device. An example of such force feedback is a spring force that increases as a lever is moved from a neutral (no input) position. Other motion control systems use mechanical-to-electrical signal transducers to translate physical operator input actions on a control input device (e.g. rotating a steering wheel) into electronic control signals for actuating a moveable component of the machine (e.g. steer-by-wire type steering systems). Such systems include electro-hydraulic machine control systems where input user actions are converted to electrical signals, and the electrical signals drive operation of hydraulic actuators that control machine operation (e.g. steered wheels, raising/lowering a scoop, etc.).

Some steer-by-wire steering systems provide force feedback to the operator manipulating the operator input device. For example, a feedback force exerted by the force feedback system against a force applied by the operator on the operator input device is determined by calculating a difference (error) between a steady-state indicated by the current position of the operator input device and the current state of a controlled parameter (e.g. steered wheel position) of the machine.

An exemplary system that may use force feedback to the operator input device in an electrical steering system is described in U.S. Pat. No. 7,516,812 to Hara et al. that issued on Apr. 14, 2009 (Hara). The system of Hara is capable of increasing the steering reaction force in a steering wheel in response to road surface reaction forces on ground wheels when the steering wheel is turning, and decreasing the steering reaction force in response to the road surface force when the steering wheel is returning. The system mitigates changes in the steering force accompanying shocks from transient increases in road surface reaction forces such that the operator can smoothly return the steering wheel to the center position.

Various types of control actions on a machine may be accomplished by a user using different types of input devices (steering wheels, joysticks, track balls, etc.). A steering wheel may be preferred for directing a machine along a road. However, a joystick may be a preferred input device for controlling machine movement during field work such as scooping dirt and loading trucks—an activity requiring repeatedly changing direction of travel. A preferred transfer function relating physical input device changes (and resulting electronic control signals) to output mechanical actions of a machine or implement may be based upon a type of activity performed by the machine. Moreover, a preferred force feedback mode exhibited by the input device may change to suit a particular use of the machine or implement.

### SUMMARY

The disclosure describes, in one aspect, a machine supporting multiple selectable operating modes for operator input devices. The machine includes a programmed controller, and an operator input device associated with an input sensor. The operator input device and associated input sensor are configured to convert physical operator actions on the operator input device into operator input control signals. Furthermore, a force feedback device, associated with the operator input device, is configured to exert a resistive force based upon force feedback signals issued by the programmed controller. A machine subsystem includes an actuator configured to change an operational state of the machine according to machine control commands issued by the programmed controller based upon the operator input control signals.

The machine further includes an operator input device configuration unit including a user interface configured to receive directions for specifying an operator input device configuration definition. The operator input device configuration definition specifies a mapping between the operator input control signals and the machine control commands, and a force feedback definition to generate the force feedback signals based, at least in part, upon the operator input control signals. Moreover, the operator input device configuration definition specifies at least an operator input device mode, and a force feedback mode corresponding to the force feedback definition is based at least in part upon the operator input device mode specified in the operator input device configuration definition.

The disclosure further describes both a method for configuring the operator input device operation for a machine and a computer-readable medium including computer executable instructions for carrying out the method.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a diagrammatic side view of a work machine in accordance with the disclosure;

FIG. 2 is a diagrammatic illustration of a machine steering/implement control system of the work machine of FIG. 1 in accordance with the disclosure;

FIGS. 3A, 3B and 3C depict three force feedback relationships based upon PIPC, PIVC and VIVC operator input device modes;

FIG. 4 is a block diagram illustrating a set of configuration definitions relating operator input device signals to related machine subsystem actions and related force feedback to a measured parameter associated with a particular operator input device mode; and

FIG. 5 is a flowchart for a method for configuring an operator control input device for the work machine in accordance with the disclosure.

### DETAILED DESCRIPTION

This disclosure relates to systems and methods that may be used to provide a highly customizable operator input interface for controlling a work machine and is associated controllable subsystems (e.g., vehicle propulsion, vehicle steering, implement actuation, etc.). The disclosure that follows uses an example of a wheel loader including hydraulically actuated steering and shovel subsystems.

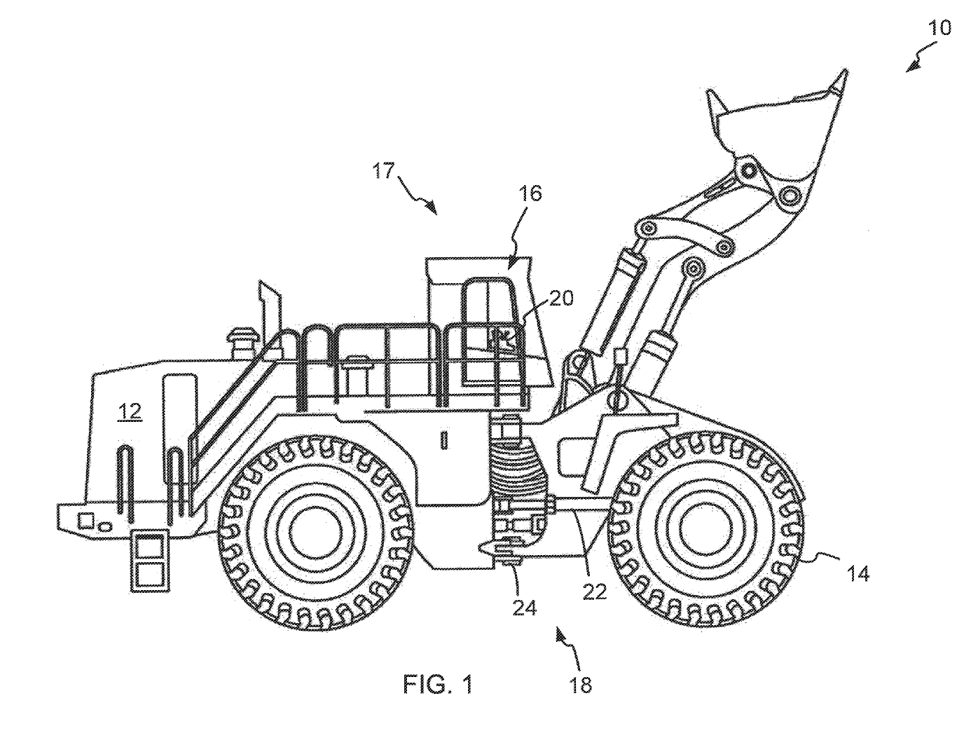

FIG. 1 illustrates an exemplary machine 10. The machine 10 may be a mobile machine that performs some type of operation associated with an industry such as mining, construction, farming, or any other industry, at a worksite. For example, the machine 10 may be an earth moving machine such as wheel loader, a haul truck, a backhoe, a lift truck, or any other operation-performing machine. The machine 10 may include a power source 12, a traction device 14, an operator station 16, and a steering system 17.

Power source 12 may be an engine, for example, a diesel engine, a gasoline engine, a gaseous fuel power engine such as a natural gas engine, or any other type of engine otherwise known in the art. The power source 12 may alternatively embody a non-combustion source of power, such as a fuel cell, a power storage device, an electric motor, or other similar mechanisms. The power source 12 may be connected to the traction device 14, thereby propelling the machine 10.

The traction device 14 may include wheels located on each side of the machine 10 (only one side shown). Alternatively, the traction device 14 may include tracks, belts, or other known fraction devices. Any of the wheels on the machine 10 may be driven and/or steered, e.g., by use of an operator input device, discussed below.

The operator station 16 may include operator input devices that receive input from a machine operator indicative of a desired steering maneuver or other machine action. Specifically, operator station 16 may include operator input devices 20. Examples of the operator input devices 20 include: steering wheels, single or multi-axis joysticks, flywheels, and other known operator physical input devices. The operator input devices 20 may be in communication with, part of, and/or otherwise associated with a steering system 17.

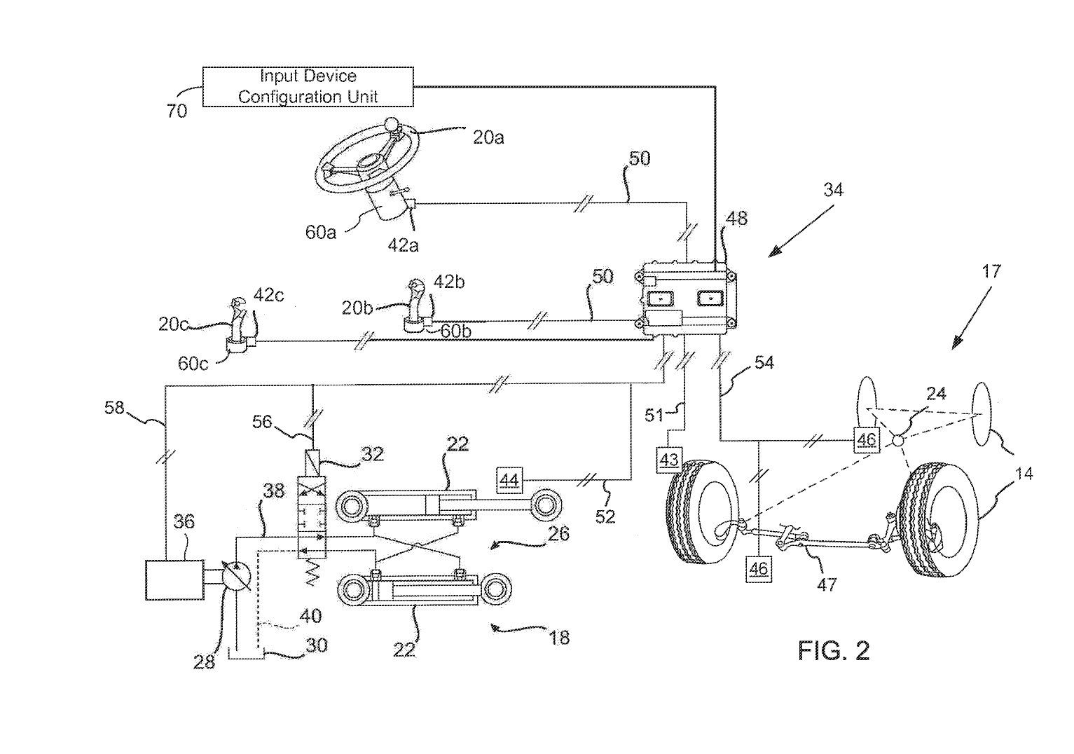

The steering system 17 may also include a steering mechanism 18, which may include one or more hydraulic cylinders 22 located on each side of the machine 10 that function in cooperation with a centrally-located articulated axis 24. To affect steering, one of the hydraulic cylinders 22, located on one side of the machine 10, may extend. Simultaneously, the other one of the hydraulic cylinders 22, located on the opposite side of the machine 10, retracts. The complementary operation of the hydraulic cylinders causes a forward end of the machine 10 to pivot about a centrally-located articulated axis 24 relative to a back end of the machine 10. Alternatively, the steering mechanism 18 may include a greater or lesser number of the hydraulic cylinders 22, and/or a different configuration of the one or more hydraulic cylinders 22 may be implemented. In some embodiments, the one or more hydraulic cylinders 22 may be implemented to have a direct connection to the traction device 14 of the machine 10. In other embodiments, the one or more hydraulic cylinder 22 may be connected to a steering linkage 47 (see FIG. 2) that transmits movement of the one or more hydraulic cylinders 22 to the front wheels, such that the front wheels turn relative to a body of machine 10. The steering linkage 47 may include a combination of rods and levers configured to translate the movement of the hydraulic cylinders 22 to the turning of the traction device 14.

The extension and retraction of the one or more hydraulic cylinders 22 may be achieved by creating an imbalance of force on a piston assembly disposed within a tube of each one of the one or more hydraulic cylinders 22. Specifically, each of the one or more hydraulic cylinders 22 may include a first chamber and a second chamber separated by the piston assembly. The piston assembly may include two opposing hydraulic surfaces, one associated with each of the first and second chambers. The first and second chambers may be complementarily supplied with a pressurized fluid and drained of the pressurized fluid to create an imbalance of force on the opposite surfaces that causes the piston to axially displace within the tube.

As illustrated in FIG. 2, the steering system 17 may also include a hydraulic circuit 26 configured to selectively supply fluid to and drain from the hydraulic cylinders 22, thereby steering the machine 10. The hydraulic circuit 26 may include a source 28 of pressurized fluid, a tank 30, a steering control valve 32, and a control subsystem 34. In various embodiments, the hydraulic circuit 26 may include additional or different components than those illustrated in FIG. 2 and listed above, such as, for example, accumulators, check valves, pressure relief or makeup valves, pressure compensating elements, restrictive orifices, and other hydraulic components known in the art.

The source 28 may produce a flow of pressurized fluid and include a variable displacement pump, a fixed displacement pump, a variable flow pump, and/or any other source of pressurized fluid known in the art. The source 28 may be drivably connected to a motor 36, such as an electric motor or an internal combustion engine. Although FIG. 2 illustrates the source 28 as being dedicated to supplying pressurized fluid to only hydraulic circuit 26, the source 28 may alternatively supply pressurized fluid to additional machine hydraulic circuits.

The tank 30 may embody a reservoir configured to hold a supply of fluid. The fluid in the tank 30 may include, for example, engine lubrication oil, transmission lubrication oil, separate hydraulic oil, or any other fluid known in the art. The source 28 may draw fluid from and return fluid to the tank 30. In various embodiments, the source 28 may be connected to multiple separate fluid tanks.

The steering control valve 32 may be connected to the source 28 via a supply line 38, and to the tank 30 via a drain line 40 to control actuation of the hydraulic cylinders 22. The steering control valve 32 may include at least one valve element that functions to meter pressurized fluid to one of the first and second chambers within each of the hydraulic cylinders 22, and to simultaneously allow fluid from the other of the first and second chambers to drain to the tank 30. In one example, the valve element of the steering control valve 32 may be a solenoid valve that mechanically opens and closes based on an electric signal controlled by a controller 48. In another example, the steering control valve 32 may be a hydraulic pilot-actuated valve. In a further example, the steering control valve 32 may move between a first position at which fluid is allowed to flow into one of the first and second chambers while allowing the fluid to drain from the other of the first and second chambers of the hydraulic cylinders 22 to the tank 30, a second position at which the flow directions are reversed, and a third position (neutral) at which fluid flow is blocked from both of the first and second chambers of the hydraulic cylinders 22. The location of the valve element between the first, second, and third positions may determine a flow rate of the pressurized fluid into and out of the associated first and second chambers of the hydraulic cylinders 22 and a corresponding steering velocity/angle rate of change (i.e., the time derivative of a steering angle) of the steering mechanism 18.

The control subsystem 34 may include components in communication with the steering system 17, the operator station 16, and/or the traction device 14 of the machine 10. In particular, the control subsystem 34 may include one or more steering input sensors 42 associated with operator input devices 20 including, for example, a steering wheel 20a, a left-side joystick 20b and/or a right-side joystick 20c, a travel speed sensor 43 associated with the traction device 14, cylinder sensors 44 associated with the hydraulic cylinders 22, and/or articulation angle sensors 46 associated with the steering mechanism 18, and a controller 48 in communication with one or more of these sensors.

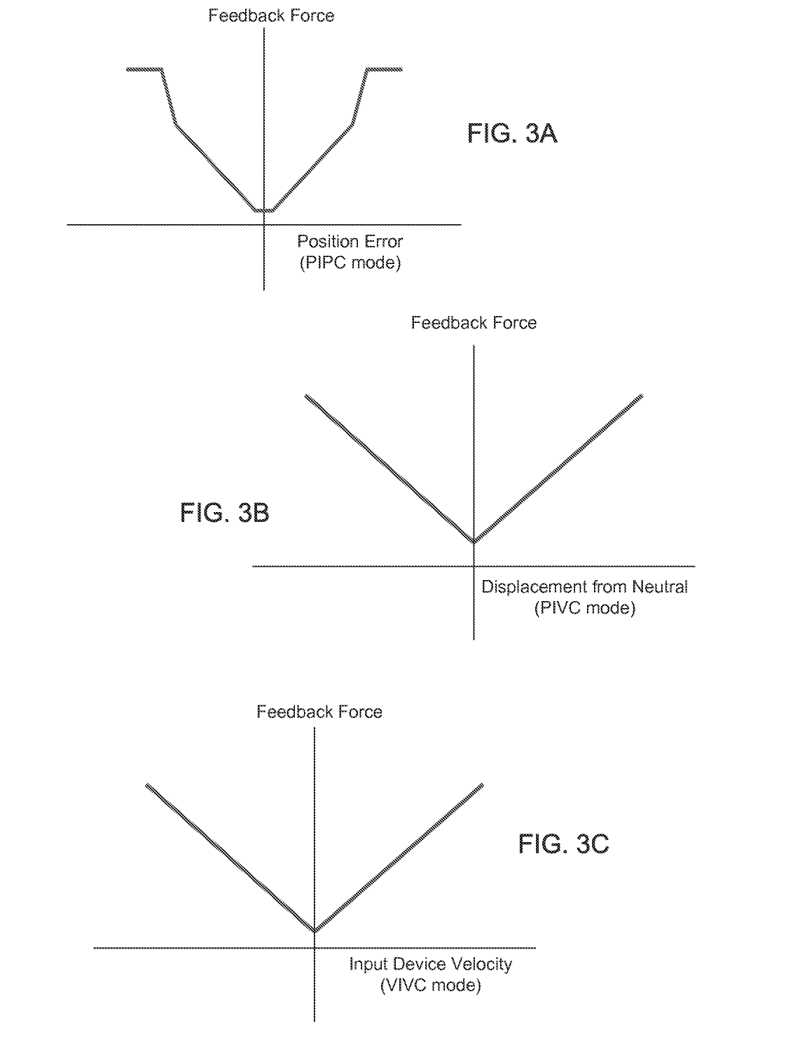

In the illustrative drive-by-wire operator input arrangement, input sensors 42a, 42b, and 42c may monitor operation of the associated operator input devices 20a, 20b and 20c (respectively) and generate corresponding signals indicative of an input operation parameter. In general, the input operation parameter may be any parameter related to the operation of a corresponding one of the operator input devices 20a, 20b and 20c, such as the position, displacement, angular velocity, angular acceleration, torque, pressure, and/or other known parameters of the operator input devices 20a, 20b and 20c. For example, the input sensor 42a for the steering wheel 20a may embody a position sensor configured to monitor a displacement angle of the steering wheel 20a. In response, the input sensor 42a generates a corresponding displacement signal. The monitored displacement angle value derived from a signal provided by the input sensor 42a may be differentiated with respect to time to calculate an angular velocity for the steering wheel 20a. Alternatively, the input sensor 42a may embody a velocity determination circuitry configured to monitor angular velocity of the steering wheel 20a and generate a corresponding signal. In this configuration, the angular velocity rendered by the input sensor 42a may be integrated to determine an incremental position of the steering wheel 20a, which may then be used to calculate displacement angle of the steering wheel 20a. For the steering wheel 20a, the displacement angle may be the angular measurement of the steering wheel displacement around a center axis of rotation. For the left-side joystick 20b and the right-side joystick 20c, positioned on either the left or right side of the operator, the displacement angle may be the tilt angle of the joystick relative to a neutral perpendicular axis extending through the joystick base. Additional aspects of the control subsystem 34, relating to configuration of relationships between the operator input devices 20 and machine actions (e.g., steering the machine 10, lifting/lowering and rotating a scoop shovel) are described further herein below with reference to an operator input device configuration unit 70 and FIG. 3.

The travel speed sensor 43 may be, for example, a magnetic pickup-type sensor. The travel speed sensor 43 may be associated with the traction device 14 and/or another drive train component of the machine 10, and may sense a rotation speed thereof and produce a corresponding speed signal. Alternatively, the travel speed sensor 43 may embody a laser sensor, a radar sensor, or other types of speed sensing devices, which may or may not be associated with a rotating component.

The cylinder sensor 44 may be associated with the one or more hydraulic cylinders 22 to produce a signal indicative of a steering operation parameter of the hydraulic cylinders 22, as the hydraulic cylinders 22 extend and retract with the supply of hydraulic fluid. In general, steering operation parameters may be any parameter related to the operation of the steering mechanism 18, such as the position, displacement, angular velocity, angular acceleration, torque, pressure, and/or other known parameters of components of the steering mechanism 18, such as the hydraulic cylinders 22, the centrally-located articulated axis 24, and/or the steering linkage 47. For example, the cylinder sensor 44 may produce a signal indicative of the position of extension/retraction, velocity of extension/retraction, acceleration of extension/retraction, and/or a pressure of the hydraulic cylinders 22. The articulation angle sensor 46 may be associated with the steering mechanism 18 to produce a signal indicative of a steering operation parameter that may include displacement, angular velocity, and/or angular acceleration of the angle between the front end of the machine 10 and the back end of the machine 10, in the situation where the steering mechanism 18 includes the centrally-located articulated axis 24. In such example, the articulation angle sensor 46 may be proximal to the centrally-located articulated axis 24 about which the front end and back end swivel. Alternatively, if the hydraulic cylinders 22 are connected such that only the front wheels are articulated, the articulation angle sensor 46 may be disposed proximal to the pivot joint about which the traction device 14 is steered. In such example, the articulation angle sensor 46 may determine a displacement, angular velocity, and/or angular acceleration of the angle between the traction device 14 and a travel direction of the machine 10, or between the traction device 14 and a central axis of the machine 10. In other embodiments, the articulation angle sensor 46 may determine a steering operation parameter, such as displacement, angular velocity, and/or angular acceleration, of an articulation angle of the steering linkage 47.

The controller 48 may include a single microprocessor or multiple microprocessors that may control an operation of the hydraulic circuit 26. Numerous commercially available microprocessors can be configured to perform the functions of the controller 48, and the controller 48 could readily embody a general machine microprocessor capable of controlling numerous machine functions. The controller 48 may include a memory, a secondary storage device, a processor, and any other components for running an application. The memory may include one or more storage devices configured to store information used by the controller 48 to perform certain functions related to embodiments described herein. The secondary storage device may include a volatile, non-volatile, magnetic, semiconductor, tape, optical, removable, non-removable, and/or other types of storage device and/or computer-readable medium. The secondary storage may store programs and/or other information, such as information related to processing data received from one or more sensors, as discussed in greater detail below. Various other circuits may be associated with the controller 48, such as power supply circuitry, signal conditional circuitry, solenoid driver circuitry, and other types of circuitry. The controller 48 is also configured to store various definitions (e.g., tables, graphs, characterizing equations, etc.) relating to the various configurations of the operator input devices 20 facilitated by the operator input device configuration unit 70 discussed further herein below.

The controller 48 may be in communication with the various components of the control subsystem 34 and the steering system 17. In particular, the controller 48 may be in communication with the input sensors 42a, 42b, and 42c (for the steering wheel 20a and joysticks 20b and 20c), the travel speed sensor 43, the cylinder sensor 44, the articulation angle sensor 46, the steering control valve 32, and/or the electric motor 36 via communication lines 50, 51, 52, 54, 56, and 58, respectively. The controller 48 may receive the steering angular displacement signal, the cylinder displacement signal, and/or the articulation angular displacement signal, as well as regulate the operation of the control steering valve 32 and/or the electric motor 36 in response to received signals.

For example, in response to a travel speed of the machine 10 and/or a steering wheel position monitored via the input sensor 42a, the controller 48 may reference (based upon a current input device configuration that may be selected via the configuration unit 70) a map stored in the memory thereof to determine a corresponding articulation angle of the centrally-located articulation axis 24 and/or the steering linkage 47. To achieve this corresponding articulation angle, the controller 48 may send signals to the steering control valve 32 and/or the electric motor 36 to control the amount and or rate of flow of hydraulic fluid that is supplied to and drained from the hydraulic cylinders 22. The reference map may include a collection of data in the form of tables, graphs, and/or equations. The reference map may define various types of relationships between one or more input operation parameters of operator input devices 20 and one or more operation parameters associated with the machine 10, including steering operation parameters of the steering mechanism 18.

A number of reference maps may be maintained by the controller 48. Such reference maps may be associated with various types of configurable relationships between the operator input devices 20 and one or more machine actions (e.g. changing steering angle). For example, the controller 48 may control the speed and/or position of the steering mechanism 18 based on the speed and/or displacement angle of the steering wheel 20a, as measured by the steering input sensor 42a.

In particular, it may be possible for one of the operator input devices 20 to operate under a position input velocity control (PIVC) relationship, wherein the speed of steering and/or the gain associated with the steering mechanism 18 may be related to a displacement of the operator input devices 20a, 20b and 20c, as measured by one of the input sensors 42a, 42b and 42c, respectively. In some situations, the steering velocity may also be related to the travel velocity of the machine 10, as measured by the travel speed sensor 43, in addition to the displacement of the particular one of the operator input devices 20 currently configured to control steering of the machine 10.

Another possibility may be for one of the operator input devices 20 to operate under a position input position control (PIPC) relationship, wherein a displacement of the steering mechanism 18 may be related and/or proportional to the displacement of one of the operator input devices 20, as well as the travel velocity of the machine 10.

Yet another possibility, generally not applicable to the joystick input devices 20b and 20c, may be for operation of the steering wheel 20a under a velocity input velocity control (VIVC) relationship, wherein a steering velocity associated with the steering mechanism 18 may be related to the rotational velocity of the steering wheel 20a, and a gain may be associated with (e.g. inversely proportional to) the travel speed of the machine 10.

In various embodiments, in addition to the above mapping between operator input actions and corresponding actions relating to operation of the machine 10, the controller 48 may also provide electronic commands to cause a specified degree of force feedback by one of the operator input devices 20a, 20b and 20c. Force feedback exerted for one of the operator input devices 20 may be a linear force and/or torque. Such force feedback may be controllably generated, for example, on the steering wheel 20a by a force feedback device 60a. The force feedback device 60a for the steering wheel 20a may be, for example, inside a housing proximal to the steering wheel 20a. Similar controllably exerted force feedback is provided for the left-side joystick 20b and the right-side joystick 20c by force feedback devices 60b and 60c, respectively. The force feedback devices 60a, 60b and 60c may include, for example, a powered actuator, such as an electric motor, drivingly connected to the operator input devices 20a, 20b and 20c, respectively.

The controller 48 may control the force feedback device 60a based on an error in an operation parameter of the steering mechanism 18. For example, the controller 48 may control a force exerted by the force feedback device 60a for the steering wheel 20a based on an error between a desired position of the steering mechanism 18 and an actual position of the steering mechanism 18. Furthermore, the controller 48 may control the force feedback device 60a based on an input operation parameter of the input sensor 42a for the steering wheel 20a. In one embodiment in which the steering system 17 is operated using a PIPC relationship, a given position of the steering wheel 20a, determined based on the input sensor 42a, may correspond with a desired position of the steering mechanism 18. However, an actual position of the steering mechanism 18 may not be the same as the desired position of the steering mechanism 18 due to, for example, the effect that irregularities in the road on which machine 10 is driving may have on the position of steering mechanism 18. Based on the error between the actual position of steering mechanism 18 and the desired position of the steering mechanism determined by input device 20, controller 48 may control force the feedback devices 60 to provide force feedback to operator input device 20.

In some embodiments, the amount of force feedback may be proportional to the error between the actual steering operation parameter of steering mechanism 18 and the desired steering operation parameter of the steering mechanism 18. For example, the amount of force feedback exerted by the force feedback device 60a on the steering wheel 20a may be proportional to the error between the actual position of steering mechanism 18 and the desired position of the steering mechanism 18. This force may simulate a resistance force that is transmitted from a steering mechanism to an operator input device in conventional mechanical steering systems. Force feedback may therefore provide the operator using the steering wheel 20a with tactile feedback regarding road conditions of a road, and/or machine performance on which the machine 10 is operating, despite the lack of a mechanical connection between the steering mechanism 18 and the steering wheel 20a.

The controller 48 may also selectively activate a force feedback device such that force feedback is not always applied to an operator input device. For example, when a steering operation parameter of the steering mechanism 18 changes, but the operator of the machine 10 has not indicated a desired change via a change in input operation parameter of the steering wheel 20a, the controller 48 may control the force feedback device 60a to not exert a feedback force on the steering wheel 20a. In a further example, when a position of the steering mechanism 18 changes, but the operator has not changed the position of the steering wheel 20a, the controller 48 may control the force feedback device 60a to not exert a corresponding feedback force on the steering wheel 20a. In doing so, the controller 48 may prevent, for example, transmitting a kickback force from the steering mechanism 18 to the operator via the steering wheel 20a when the machine 10 suddenly comes into contact with an obstruction, obstacle, protrusion, and/or depression in the road.

The control subsystem 34, and in particular the controller 48, is provided with a high degree of operator-designated configurability with regard to relationships between operator actions on the operator input devices 20a, 20b and 20c and resulting actions carried out by mechanical subsystems of the machine 10. Such relationships may be implemented via mapping supported by the controller 48 for the machine 10 comprising multiple electro-hydraulically controlled subsystems for carrying out various machine actions including: steering, forward-reverse movement, and lifting/lowering and rotating a scoop/shovel implement. At least some aspects of such relationships may be configured automatically within the controller 48 based upon sensed inputs relating to the status of the machine 10. Alternatively, or additionally, the relationships may be specified via the operator input device configuration unit 70.

Each subsystem may be operated in a variety of configurable operator input device modes including: PIPC, PIVC and VIVC. In particular, the steering wheel 20a may be configured to operate in PIPC, PIVC and VIVC modes. The left-side joystick 20b and the right-side joystick 20c may be operated in the PIPC and PIVC, but not the VIVC mode.

Moreover, each of the different operator input device modes (PIPC, PIVC and VIVC) may be associated with a distinct force feedback definition. Turning briefly to FIGS. 3A, 3B and 3C, a set of exemplary force feedback relationships are graphically depicted. Turning to FIG. 3A, an exemplary relationship is depicted for force feedback while one of the operator input devices 20 operates in a PIPC mode. In the illustrative example of FIG. 3A, the degree of counter force exerted by, for example, the force feedback device 60a on the steering wheel 20a increases as the position error increases. As noted above, the position error is based upon a comparison between a desired (steering) position and an actual steering position as currently registered by the controller 48. The shape of the force curve depicted in FIG. 3A is merely exemplary, and the small force at zero position error represents a holding force on the input device. Upon release of the input device, it would remain in place with the holding force of the force feedback device.

Turning to FIG. 3B, an exemplary relationship is depicted for force feedback while one of the operator input devices 20 operates in a PIVC mode. In the illustrative example of FIG. 3B, the degree of counterforce exerted by, for example, the force feedback device 60a on the steering wheel 20a increases as the displacement from a neutral position (e.g. machine 10 is not turning) increases. As noted above, as the steering wheel or joystick is moved farther from a neutral position, the velocity of the controlled subsystem increases and the counterforce exerted by the force feedback device increases. The shape of the force curve depicted in FIG. 3B is merely exemplary, and the small force at zero position error represents a holding force on the input device. Further, upon release of the input device, the force feedback device will return the input device to its neutral (centered) position.

Turning to FIG. 3C, an exemplary relationship is depicted for force feedback while one of the operator input devices 20 operates in a VIVC mode. In the illustrative example of FIG. 3C, the degree of counterforce exerted by, for example, the force feedback device 60a on the steering wheel 20a increases as the rotational velocity of the steering wheel 20a increases (commanding an associated subsystem of the machine 10 to perform a requested action faster). The shape of the force curve depicted in FIG. 3C is merely exemplary, and the small force at zero position error represents a holding force on the input device. Further, upon release of the input device, it will remain in place and be held in position by the holding force of force feedback device.

With continued reference to FIG. 2, configuring the operator input device, facilitated by configuration selections that may be submitted by a user via the operator input device configuration unit 70 includes: (1) designating one of the operator input devices 20a, 20b and 20c to control a particular machine subsystem (e.g., steering wheels, lifting/lowering and rotating a scoop shovel), (2) mapping physical manipulation of the operator input devices 20a, 20b, and 20c to the designated machine subsystem, and (3) specifying a force feedback mode of operation exerted on the operator input devices 20a, 20b and 20c by the force feedback devices 60a, 60b and 60c.

The system described herein permits designating a joystick control for controlling movement of the machine 10. While operating the machine 10 on a road, a steering system associated with the side-to-side (x axis) movement of the joystick control is designated to operate in a PIPC mode when the machine 10 is operated on a road. Moreover, the controller 48 automatically selects a PIPC-based force feedback mode (see FIG. 3A) for the joystick. Later, while the machine 10 is operating in a work mode (i.e. scooping and moving material) the steering system associated with the side-to-side (x-axis) movement of the joystick control is designated to operate in a PIVC mode. Moreover, the controller 48 automatically selects a PIVC-based force feedback mode (see FIG. 3B) for the joystick.

The system described herein permits designating a steering wheel control for controlling movement of the machine 10. Similar selectable relationship mapping options are supported for the steering wheel 20a used to control the steering mechanism 18 for the machine 10. However, in the case of selection of the steering wheel 20a for controlling steering on the machine 10, the VIVC relationship between the steering wheel 20a and the steering mechanism 18 is also potentially selectable. In such case, the controller 48 may automatically select the force feedback definition (see FIG. 3C) corresponding to the VIVC operating mode for the steering wheel 20a in response to selection of the VIVC mode of operating the steering wheel 20a.

The operator input device configuration unit 70 may comprise any of a wide variety of interface types. The configuration unit 70 may be a set of physical switches enabling/disabling particular operational modes. Alternatively, the configuration unit 70 may be a graphical user interface incorporating a touch-screen interface and configured, among other things, to present a series of hierarchically linked displays. The hierarchically displays list configuration options at each level as well as links to adjacent decision levels. Thus, the configuration unit 70 may be used to completely designate relationships between particular operator input devices and corresponding subsystems of the machine 10. The form and function of the configuration unit 70 varies substantially in accordance with various implementations. The configurations could also be limited by controller 48 in any manner, such as in accordance with configuration limitations specified by an original equipment manufacturer.

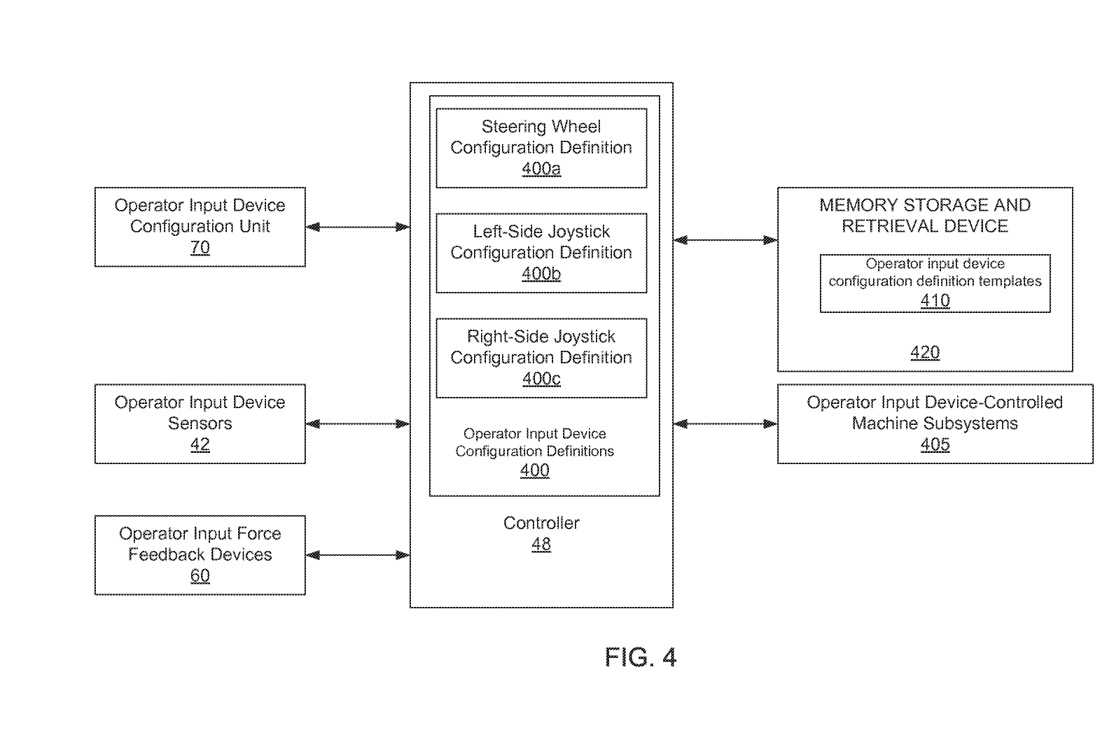

Turning to FIG. 4, a schematic drawing depicts the controller 48 as well as components of the machine 10 that may be communicatively coupled to the controller 48 to facilitate configuring, based on operator input device configuration parameter values provided from the operator input device configuration unit 70, operator input device configuration definitions 400. The operator input device configuration definitions 400 specify relationships (carried out by the controller 48) between the operator input devices 20 and associated operator input device sensors 42 (that provide operator input control signals), and subsystems 405 of the machine 10. The configuration definitions 400 also specify a force feedback mode that causes the controller 48 to issue force feedback signals to the operator input force feedback devices 60 based, in part, upon observed operational parameter values of corresponding (physically coupled) operator input devices 20. In the illustrative example, the definitions 400 include: a steering wheel configuration definition 400a, a left-side joystick configuration definition 400b, and a right-side joystick configuration definition 400c.

The operator input device configuration definitions 400 are created based upon operator input device configuration definition templates 410 that may be stored on a memory storage and retrieval device 420. By way of example, the operator input device configuration definition templates 410 include a set of data structures and/or computer-executable instructions identified by a combination of: operator input device type, machine subsystem (controlled machine element—e.g., steering subsystem), and operator input device mode. Thus, a first configuration definition template is provided for a first configuration combination including: a joystick, steering subsystem, and PIPC mode. A second configuration template is provided for a second configuration combination including: a joystick, steering subsystem and PIVC mode. The manner of defining configurations through the use of templates is merely exemplary, and the specification of configured operator input device configuration definitions may be accomplished in a wide variety of ways in accordance with various implementations of the machine 10 supporting multiple selectable operating modes for operator input devices.

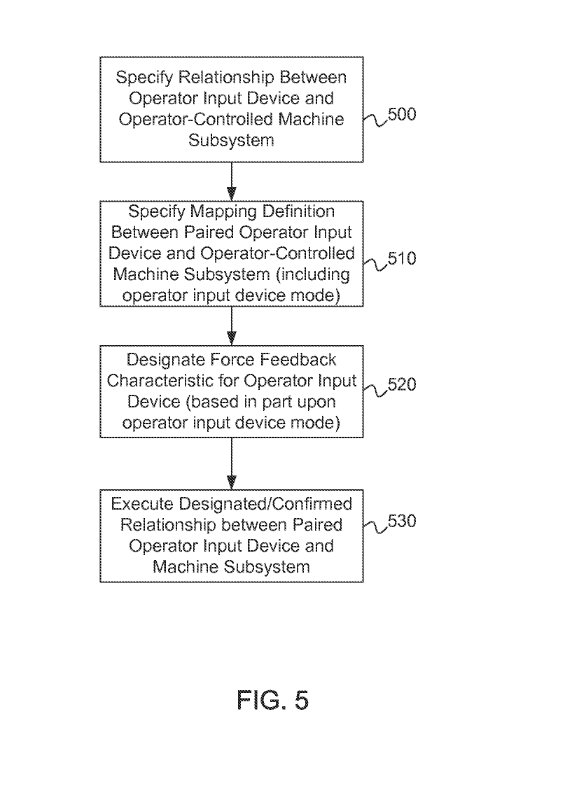

Turning to FIG. 5 a flow chart summarizes steps of an exemplary method for selectively configuring the functionality of a variety of operator input devices, such as for example the steering wheel 20a, the left-side joystick 20b and the right-side joystick 20c of the machine 10 depicted in FIG. 2. FIG. 5 will be discussed in the following section to further illustrate the disclosed system and its operation.

### INDUSTRIAL APPLICABILITY

The disclosed system may be applicable to any machine, such as machine 10, where is it desirable to support selective configuration of particular ones of multiple operator input device modes and related force feedback modes. The described system may address this need through the use of methods described herein. The methods may be performed by the controller 48. Operation of system described herein above will now be explained with respect to FIG. 5.

Initially, during step 500, a relationship is specified between one of the operator input devices 20 and a corresponding operator-controlled subsystem of the machine 10. By way of example, an operator causes the configuration unit 70 to provide a listing of subsystems (e.g., steering) of the machine 10 that may be configured to be operated by a designated one of multiple available operator input devices (e.g., operator input devices 20a, 20b and 20c). In response to a user selecting one of the listed subsystems, such as the steering subsystem, causes the configuration unit 70 to display a listing of the operator input devices that may be potentially designated to control the selected subsystem. By way of example, the configuration unit 70 may identify the steering wheel 20a, the left-side joystick 20b and the right-side joystick 20c as potentially selectable operator input devices for the steering subsystem. The user completes designation of the relationship by selecting one of the listed operator input devices.

Thereafter, during step 510, a mapping definition is designated, from a set of available definitions maintained on the controller 48 (see FIG. 4), between operator actions on the selected operator input device and resulting control instructions issued by the controller 48 to the subsystem selected during step 500. The mapping definition, in accordance with the disclosure herein, may be generally characterized by PIPC, PIVC and VIVC modes of operation. However, additional details (e.g., gain, delay, filtering, etc.) defining the mapped relationships between the paired operator input device and machine subsystem are also specified to configure the operation of the controller 48 when processing input from the operator input device to render control signals to the affected machine subsystem.

Thereafter, during step 520, a force feedback characteristic is designated for controlling a force feedback device for the selected operator input device (e.g., force feedback device 60b for left-side joystick 20b). The general feedback mode is generally specified automatically in accordance with a previously designated operator input device mode (e.g., PIPC, PIVC and VIVC). However, a particular customized feedback response can be designated including the magnitude of the force, the slope/shape of the parameter-force response curve, filtering, etc.

After a user confirms the relationship definition established by the steps 500, 510 and 520, control passes to step 530 wherein the controller 48 executes the designated/confirmed relationship.

The industrial applicability of the system described herein should be readily appreciated from the foregoing discussion. The present disclosure may be included as part of a work machine such as an off-road machine of which a wheel loader is a particular example.

The systems described above can be adapted to a large variety of machines and tasks. For example, other types of industrial machines, such as backhoe loaders, compactors, feller bunchers, forest machines, industrial loaders, skid steer loaders, wheel loaders and many other machines can benefit from the system described.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A machine supporting multiple selectable operating modes for operator input devices, the machine comprising:
a programmed controller;
an operator input device associated with an input sensor, the operator input device and associated input sensor being configured to convert physical operator actions on the operator input device into operator input control signals;
a force feedback device, associated with the operator input device, configured to exert a resistive force based upon force feedback signals issued by the programmed controller;
a machine subsystem including an actuator configured to change an operational state of the machine according to machine control commands issued by the programmed controller based upon the operator input control signals;
an operator input device configuration unit including a user interface configured to receive directions for specifying an operator input device configuration definition, wherein the operator input device configuration definition specifies:
a mapping between the operator input control signals and the machine control commands, and
a force feedback definition to generate the force feedback signals based, at least in part, upon the operator input control signals;
wherein the operator input device configuration definition specifies at least an operator input device mode, and a force feedback mode corresponding to the force feedback definition is based at least in part upon the operator input device mode specified in the operator input device configuration definition.

2. The machine of claim 1 wherein the machine includes multiple operator input devices associated with corresponding input sensors that are configurable to provide operator input control signals for the machine subsystem, and wherein the operator input device configuration unit user interface supports designating one of the multiple operator input devices to control the machine subsystem.

3. The machine of claim 2 wherein the multiple operator input devices include at least a steering wheel and a joystick.

4. The machine of claim 1 wherein the machine subsystem comprises machine steering components.

5. The machine of claim 1 wherein the machine subsystem comprises machine propulsion components.

6. The machine of claim 1 wherein the machine subsystem comprises shovel implement components.

7. The machine of claim 1 wherein the operator input device mode is taken from the group consisting of:
a position input position control (PIPC) mode;
a position input velocity control (PIVC) mode; and
a velocity input velocity control (VIVC) mode.

8. The machine of claim 1 wherein the operator input device configuration definition is created from an operator input device configuration definition template accessed by the programmed controller in response to configuration instructions received from the operator input device configuration unit.

9. A method for configuring a machine supporting multiple selectable operating modes for operator input devices, wherein the machine comprises a programmed controller, an operator input device, an operator input device configuration unit, a force feedback device associated with the operator input device configured to exert a resistive force based upon force feedback signals issued by the programmed controller, the method comprising:
receiving configuration instructions, via the operator input device configuration unit, for specifying a mapping between the operator input device and a machine subsystem, wherein the operator input device and an associated input sensor are configured to convert physical operator actions on the operator input device into operator input control signals, and wherein the machine subsystem includes an actuator configured to change an operational state of the machine according to machine control commands issued by the programmed controller based upon the operator input control signals; and
creating an operator input device configuration definition based upon the configuration instructions, wherein the operator input device configuration definition specifies:
a mapping between the operator input control signals and the machine control commands, and
a force feedback definition to generate the force feedback signals based, at least in part, upon the operator input control signals;
wherein the operator input device configuration definition specifies at least an operator input device mode, and a force feedback mode corresponding to the force feedback definition is based at least in part upon the operator input device mode specified in the operator input device configuration definition.

10. The method of claim 9 wherein the machine includes multiple operator input devices associated with corresponding input sensors that are configurable to provide operator input control signals for the machine subsystem, and wherein the configuration instructions received from the operator input device configuration unit user interface designate one of the multiple operator input devices to control the machine subsystem.

11. The method of claim 10 wherein the multiple operator input devices include at least a steering wheel and a joystick.

12. The method of claim 9 wherein the machine subsystem comprises machine steering components.

13. The method of claim 9 wherein the machine subsystem comprises machine propulsion components.

14. The method of claim 9 wherein the machine subsystem comprises shovel implement components.

15. The method of claim 9 wherein the operator input device mode is taken from the group consisting of:
a position input position control (PIPC) mode;
a position input velocity control (PIVC) mode; and
a velocity input velocity control (VIVC) mode.

16. The method of claim 9 wherein during the creating, the operator input device configuration definition is created from an operator input device configuration definition template accessed by the programmed controller in response to configuration instructions received from the operator input device configuration unit.

17. A non-transitory computer-readable medium including computer-executable instructions for configuring a machine supporting multiple selectable operating modes for operator input devices, wherein the machine comprises a programmed controller, an operator input device, an operator input device configuration unit, a force feedback device associated with the operator input device configured to exert a resistive force based upon force feedback signals issued by the programmed controller, the computer-executable instructions, when executed by the programmed controller, facilitating performing the steps of:
receiving configuration instructions, via the operator input device configuration unit, for specifying a mapping between the operator input device and a machine subsystem, wherein the operator input device and an associated input sensor are configured to convert physical operator actions on the operator input device into operator input control signals, and wherein the machine subsystem includes an actuator configured to change an operational state of the machine according to machine control commands issued by the programmed controller based upon the operator input control signals; and
creating an operator input device configuration definition based upon the configuration instructions, wherein the operator input device configuration definition specifies:
a mapping between the operator input control signals and the machine control commands, and
a force feedback definition to generate the force feedback signals based, at least in part, upon the operator input control signals;
wherein the operator input device configuration definition specifies at least an operator input device mode, and a force feedback mode corresponding to the force feedback definition is based at least in part upon the operator input device mode specified in the operator input device configuration definition.

18. The non-transitory computer-readable medium of claim 17 wherein the machine includes multiple operator input devices associated with corresponding input sensors that are configurable to provide operator input control signals for the machine subsystem, and wherein the configuration instructions received from the operator input device configuration unit user interface designate one of the multiple operator input devices to control the machine subsystem.

19. The non-transitory computer-readable medium of claim 17 wherein the operator input device mode is taken from the group consisting of:
a position input position control (PIPC) mode;
a position input velocity control (PIVC) mode; and
a velocity input velocity control (VIVC) mode.

20. The non-transitory computer-readable medium of claim 17 wherein during the creating, the operator input device configuration definition is created from an operator input device configuration definition template accessed by the programmed controller in response to configuration instructions received from the operator input device configuration unit.
